(19) United States
(12) Patent Application Publication
(10) Pub. No.: US 2008/0199706 A1
(43) Pub. Date: Aug. 21, 2008

(54) POLYURETHANE ELASTOMERIC ADHESIVE COMPOSITION AND COMPOSITE ARTICLE FORMED THEREFROM

(76) Inventors: Kristy Bacher, Dundas (CA); Katrina Schmidt, Oakville (CA); Greg Gardin, Cambridge (CA)

Correspondence Address: BASF AKTIENGESELLSCHAFT, CARL-BOSCH STRASSE 38, 67056 LUDWIGSHAFEN, LUDWIGSHAFEN, 69056, omitted

(21) Appl. No.: 11/677,066

(22) Filed: Feb. 21, 2007

(51) Int. Cl. C08G 18/00

(52) U.S. Cl. 428/425.9; 428/423.1; 525/452

(57) ABSTRACT

A resin composition is reacted with a polyisocyanate composition to form a polyurethane elastomeric adhesive. The polyurethane elastomeric adhesive adheres a first substrate to a second substrate to form a composite article. The resin composition comprises a first isocyanate-reactive component, a catalyst component, and a chelating agent. The first isocyanate-reactive component comprises an internal block copolymer formed from an initiator and an alkylene oxide and comprises terminal isocyanate-reactive groups. The chelating agent comprises a branched polymeric amine having a weight-average molecular weight of from about 800 to about 200,000 and is present in an amount of from about 1 to about 10 parts by weight based on 100 parts by weight of the resin composition.

### BACKGROUND OF THE INVENTION

1. Field of the Invention

The subject invention relates to a polyurethane elastomeric adhesive composition, and more specifically to a composite article formed with the polyurethane elastomeric adhesive.

2. Description of the Prior Art

Various adhesives are known for bonding or adhering multiple substrates to one another to form a composite article. Generally, these substrates are metal or plastic. One particular adhesive is a polyurethane elastomeric adhesive and is the reaction product of a polyisocyanate composition and a resin composition. These polyurethane elastomeric adhesives are suited for adhering particular substrates to one another. However, these polyurethane elastomeric adhesives are not suited for adhering other substrates together because an inadequate bond is formed therebetween and the peel strength is insufficient. One example of a substrate that does not bond well with polyurethane elastomeric adhesives is galvanized metal.

It is well known to treat a surface of the substrate prior to adhering two substrates together with an adhesive. One specific type of galvanized metal that requires such pre-treatment is galvanized steel. Galvanized steel has undergone a process and has been coated to prevent the steel from corroding. Zinc is most often used to coat the steel. When steel is submerged in melted zinc, the chemical reaction permanently bonds the zinc to the steel through galvanizing. The zinc interferes with the adhesive from securely bonding to the steel. Thus, a primer designed to interact with the zinc and the steel is applied to the surface before applying the adhesive. Various primers to be applied prior to the adhesive are known to those skilled in the art for improving bonding to galvanized metals.

One such primer is sold under the trade name Lupasol® from BASF Corporation. Lupasol® is a chelating agent and is known to make coatings, colors, and adhesives stick better to porous and non-porous surfaces. Further, Lupasol® promotes adhesion between dissimilar materials, such as different types of plastics or other polar substrates. The application of Lupasol® to the surface of the substrate occurs prior to the disposing the adhesive on the surface. The application of the primer prior to the application of the adhesive requires additional manufacturing steps, thereby increasing the cost of manufacturing the composite article.

One example of a coating is shown in U.S. Pat. No. 5,990,224, which discloses a waterborne polymer composition for use as a coating. The '224 patent incorporates a polyalkylenimine into the polymer composition to stabilize the composition from gelling. More specifically, the polyalkylenimine is present when the polymerization occurs.

Lupasol® has also been used with polyurethane foams as a scavenger. One example is shown in United States Patent Application Publication No. 2004/0198851, which discloses a polyurethane foam that has a polyalkylenimine applied to the surface thereof. The foam is milled to give foam particles and then the particles are shaken in the present of the polyalkylenimine. The coated foam is used to adsorb heavy metal ions and odorous substances from liquids.

### SUMMARY OF THE INVENTION AND ADVANTAGES

The subject invention provides a resin composition for forming a polyurethane elastomeric adhesive. The polyurethane elastomeric adhesive is particular useful in forming a composite article. The resin composition generally comprises a first isocyanate-reactive component, a catalyst component, and a chelating agent. The first isocyanate-reactive component comprises an internal block copolymer formed from an initiator and an alkylene oxide and comprises terminal isocyanate-reactive groups. The first isocyanate-reactive component is present in an amount of from about 25 to about 75 parts by weight based on 100 parts by weight of the resin composition and has a number-average molecular weight of from about 400 to about 4000. The chelating agent comprises a branched polymeric amine having a weight-average molecular weight of from about 800 to about 200,000 and is present in an amount of from about 1 to about 10 parts by weight based on 100 parts by weight of the resin composition.

To form the polyurethane elastomeric adhesive, the resin composition is reacted with a polyisocyanate composition. The composite article comprises a first substrate and a second substrate spaced from one another with the polyurethane elastomeric adhesive disposed between the substrates to adhere the substrates to one another.

To date, Lupasol® has not been integrated into a polyurethane elastomeric adhesive for forming a composite article and for increasing the peel strength between substrates. It is appreciated by those of ordinary skill in the art of polyurethane elastomeric adhesives that merely incorporating such a component into the system may result in various challenges and difficulties, such as chelating the catalysts, causing separation issues in the resin, and effecting viscosity or reactivity of the resin. Specifically, incorporating such a reactive component into the system may disrupt the structure of the polyurethane elastomeric adhesive. Further, incorporating the chelating agent throughout the resin composition, while still achieving the result of an adequate bond between the substrates, may be difficult without directly applying the chelating agent to the surface of the substrate.

The subject invention provides an adequate bond between the substrates even when dispensing the chelating agent throughout the resin composition. The subject invention achieves a peel strength between the substrates of at least 10 pounds per linear inch at 25° C. Another aspect of the subject invention is that the substrates can be adhered to one another without requiring additional steps, such as priming the substrates. This is particularly true with metal substrates, such as galvanized steel, that typically require priming prior to being adhered together.

### DETAILED DESCRIPTION OF THE INVENTION

A polyurethane elastomeric adhesive is disclosed. The polyurethane elastomeric adhesive is particularly useful for forming a composite article. Specifically, the composite article generally comprises a first substrate and a second substrate spaced from one another with the polyurethane elastomeric adhesive disposed therebetween. The polyurethane elastomeric adhesive adheres the first and second substrates to one another. The subject invention provides the composite article having a peel strength of at least about 10 pounds per linear inch. The peel strength should be achieved at normal temperatures. While not necessary, it is also desirable that the composite article maintain this peel strength after being heated in a 200° C. oven for an hour and with limited degradation over time.

The first and second substrates may be selected from the group of metal materials, plastic materials, and combinations thereof. At least one of the first and second substrates is free of primers, and preferably, both are free of primers. Achieving the desired peel strength without having to apply a primer reduces the number of steps in preparing the composite article, thereby reducing the cost of the same. Further, when primers are applied, a buffering step must be incorporated into the manufacturing process to allow the primer sufficient time to dry. The buffering step further increases the cost of manufacturing such composite articles.

Preferably, the first substrate is a metal material and more preferably, the first substrate is galvanized. One type of galvanized metal used in the subject invention is galvanized steel. The second substrate is preferably a metal material and more preferably galvanized steel.

In addition to the first and second substrates, the composite article may further comprise a reinforcing material disposed between the substrates. The reinforcing material may be a fibrous core or sheet, such as paper sheets or burlap sheets. Another suitable reinforcing material may be polypropylene based sheets. The reinforcing material may include a single layer or multiple layers depending upon the particular application. It is common for particular applications to include up to 20 fibrous sheets between the first and second substrates.

Generally, the first and second substrates are spaced from one another by about 0.1 to about 20 mm depending upon the amount of the polyurethane elastomeric adhesive and whether the reinforcing material is present. If no reinforcing material is present, then the substrates are preferably spaced from one another by about 0.1 to about 2 mm.

The polyurethane elastomeric adhesive comprises the reaction product of a polyisocyanate composition and a resin composition. The polyisocyanate composition generally corresponds to the formula R(NCO)_{z} wherein R is an organic chain and z is an integer which corresponds to the functionality of R and z is at least two. R may include an aromatic group, however, R may also be an aliphatic group. Representative of the types of organic polyisocyanates contemplated herein include, for example, bis(3-isocyanatopropyl)ether, 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisochyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, and 3,3′-dimethyldiphenylmethane-4,4′-diisocyanate; triisocyanates such as 4,4′,4″-triphenylmethane triisocyanate; polymeric isocyanates such as polymethylene polyphenylene polyisocyanate and 2,4,6-toluene triisocyanate; and tetraisocyanates such as 4,4′-dimethyl-2,2′-5,5′-diphenylmethane tetraisocyanate.

The polyisocyanate composition is preferably selected from the group of monomeric diphenylmethane diisocyanate, polymeric diphenylmethane diisocyanate, and combinations thereof. Especially useful are monomeric diisocyanates including 2,4′-diphenylmethane diisocyanate, 4,4′-diphenylmethane diisocyanate, and combinations thereof. Suitable diphenylmethane diisocyanates may be pure, i.e. solely 4,4′-diphenylmethane diisocyanate, or mixtures containing both 4,4′-diphenylmethane diisocyanate and 2,4′-diphenylmethane diisocyanate isomers.

The polymeric diphenylmethane diisocyanate will generally be obtained from a mixture of methylene diphenyl diisocyanate isomers, triisocyanates, and higher functional oligomers. Suitable polymeric diphenylmethane isocyanates will generally contain a certain percentage of methylene diphenyl diisocyanate isomers with the remainder being the desired 3-ring and higher functional oligomers.

Examples of suitable polyisocyanate components include, but are not limited to, Elastoflex® 5120, Lupranate® M20S, and Lupranate® MP102, Lupranate® MM103, or mixtures thereof, commercially available from BASF Corporation.

The resin composition generally comprises a first isocyanate-reactive component, optionally a second isocyanate-reactive component, a catalyst component, and a chelating agent. The first isocyanate-reactive component is formed from an initiator, such as a diol or a triol, and comprises an internal block copolymer formed from an alkylene oxide. The internal block copolymer is preferably formed from at least 50% propylene oxide and more preferably at least 75%. The first isocyanate-reactive component further comprises terminal isocyanate-reactive groups. The terminal isocyanate-reactive groups preferably comprise from greater than 0 to about 30 percent ethylene oxide groups based on 100 percent by weight of the first isocyanate-reactive composition. Suitable examples of the first isocyanate-reactive component include, but are not limited to, Pluronic® L62 Pluracol® P2010, Pluracol® 1062, or Pluracol® 1010, each commercially available from BASF Corporation.

The first isocyanate-reactive component has a number-average molecular weight of from about 400 to about 4000. Preferably, the number-average molecular weight is from about 1000 to about 4000, and more preferably form about 2000 to about 4000. The first isocyanate-reactive component has a hydroxyl number from about 20 to about 100, preferably from about 20 to about 75, and more preferably from about 40 to about 75.

The first isocyanate-reactive component is present in an amount of from about 25 to about 75 parts by weight based on 100 parts by weight of the resin composition. Preferably, the first isocyanate-reactive component is present in an amount of from about 35 to about 75 parts by weight, and more preferably from about 50 to about 70 parts by weight, both based on 100 parts by weight of the resin composition.

The second isocyanate-reactive component, if present, is different than the first isocyanate-reactive component and has a hydroxyl number of from about 75 to about 550 and has a number-average molecular weight of from about 750 to about 1500. Preferably, the hydroxyl number is from about 200 to about 550, and more preferably from about 350 to about 550. The second isocyanate-reactive component has a theoretical functionality of 3 or greater, preferably 4 or greater, and more preferably 4. The terminology “actual functionality” is the functionality of the polyol after manufacture, whereas the terminology “theoretical functionality” is the functionality expected based upon the functionality of the initiator molecule, as understood by those skilled in the art. The second isocyanate-reactive component is selected based upon the desired properties of the polyurethane elastomeric adhesive. Suitable examples of the second isocyanate-reactive component include, Pluracol® 1016, Pluracol® 735, Pluracol® 736, Pluracol® 824, Pluracol® 922, and Pluracol® 975, each commercially available from BASF Corporation.

The second isocyanate-reactive component is present in an amount of from about 1 to about 40 parts by weight based on 100 parts by weight of the resin composition. Preferably, the second isocyanate-reactive component is present in an amount of from about 1 to about 25 parts by weight, and more preferably from about 1 to about 15 parts by weight, both based on 100 parts by weight of the resin composition.

The catalyst component may be selected from an amine catalyst, a metal catalyst, or mixtures thereof. Examples of catalysts include, but are not limited to, lead octoate, tin octoate, and the like. The catalyst is present in an amount of from about 0.001 to about 0.5 parts by weight based on the 100 parts by weight of the resin composition.

The chelating agent comprises a branched polymeric amine having a weight-average molecular weight of from about 800 to about 200,000. Preferably, the chelating agent has a weight-average molecular weight of from about 5,000 to about 150,000 and more preferably from about 15,000 to about 75,000. The branched polymeric amine is preferably a polyalkylenimine having at least one primary, at least one secondary, and at least one tertiary amine group. The branched polymeric amine is selected from the group of ethylenimines, polyethylenimines, polyvinylamines, polyvinylamine copolymers, carboxymethylated polyethylenimines, phosphonomethylated polyethylenimines, quaternized polyethylenimines, dithiocarbamatized polyethylenimines, and mixtures thereof. Suitable chelating agents are commercially available as Lupasol® WF, Lupasol® G, Lupasol® HF, Lupasol® FC, Lupasol® FG, and Lupasol® PR.

The chelating agent is present in an amount of from about 0.5 to about 10 parts by weight based on 100 parts by weight of the resin composition. Preferably, the chelating agent is present in an amount of from about 1 to about 8 parts by weight, and more preferably from about 2.5 to about 7.5 parts by weight, both based on 100 parts by weight of the resin composition. It was discovered that the peel strength plateaued once the chelating agent exceed 10 parts by weight and thus increasing the amount beyond 10 parts by weight did not provide significant advantages.

The resin composition may further comprise a monol having a hydrocarbon chain of at least 4 atoms. Preferably, the monol has a hydrocarbon chain of at least 8 atoms. It is further preferred that the monol comprises a blend of primary alcohols and each primary alcohol has a hydrocarbon chain of at least 8 atoms and greater. A suitable monol is commercially available as NEODOL® 25 from Shell Chemicals. NEODOL® 25 is a blend of monols that has hydrocarbon chains of 12, 13, 14, and 15 atoms. Another suitable monol is commercially available as ISALCHEM® 125 from Sasol.

The monol is present in an amount of from about 1 to about 20 parts by weight based on 100 parts by weight of the resin composition. Preferably, the monol is present in an amount of from about 1 to about 15 parts by weight, and more preferably from about 1 to about 10 parts by weight, both based on 100 parts by weight of the resin composition. It was discovered that even though the peel strength plateaued with increasing amounts of chelating agent, the peel strength further increased with the addition of the monol.

The resin composition may further include chain extender component. As is understood by those of ordinary skill in the art, chain extenders include two reactive groups, i.e., a diol. The chain extender component is selected from the group of ethylene glycol, diethylene glycol, propylene glycol, butylene glycol, and mixtures thereof. One example of a suitable chain extender is Pluracol E600 commercially available from BASF Corporation. The chain extender is present in an amount of from about 1 to about 45 parts by weight based on 100 parts by weight of the resin composition. Preferably, the chain extender is present in an amount of from about 5 to about 30 parts by weight, and more preferably from about 10 to about 25 parts by weight, both based on 100 parts by weight of the resin composition.

The resin composition may also include an anti-foaming agent. The subject invention seeks to reduce or eliminate foaming that may result from the reaction of the polyisocyanate composition and the resin composition. Further, the subject invention provides the polyurethane elastomeric adhesive, which is different than polyurethane foams, as a result of the reduced or eliminated foaming. In the alternative, the resin composition may be free of blowing agents, physical or chemical. It is to be appreciated that water, which is a known chemical blowing agent, may be present in various components, however, it will be present only in minor amounts and should not significantly contribute to foaming.

In achieving the desired peel strength of the polyurethane elastomeric adhesive, it was determined that the polyisocyanate composition and the resin composition should reacted in an amount to have an isocyanate index of from about 80 to about 110. When the isocyanate index exceeds 110, the polyurethane elastomeric adhesive become too brittle. Preferably, the isocyanate index is from about 85 to about 105, and more preferably from about 90 to about 100.

The following examples, illustrating the formation of the composite article according to the subject invention, as presented herein, are intended to illustrate and not limit the invention.

### EXAMPLES

A polyurethane elastomeric adhesive is prepared from the components listed in the below table. The components are in parts by weight, unless otherwise indicated.

TABLE 1
Polyurethane Elastomeric Adhesive Formulations

| Resin Composition | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| 1st Isocyanate-Reactive | 39.38 | 43.38 | 41.88 | 64.25 | 37.00 | — | — | — | — |
| Component A | | | | | | | | | |
| 1st Isocyanate-Reactive | — | — | — | — | 37.00 | — | — | — | — |
| Component B | | | | | | | | | |
| 1st Isocyanate-Reactive | — | — | — | — | — | 37.00 | 37.00 | 37.00 | 37.00 |
| Component C | | | | | | | | | |
| 1st Isocyanate-Reactive | — | — | — | — | — | 37.00 | 37.00 | 32.00 | 32.00 |
| Component D | | | | | | | | | |
| 2nd Isocyanate- | 5.00 | 5.00 | 5.00 | 5.00 | 5.00 | 5.00 | 5.00 | 5.00 | 5.00 |
| Reactive Component | | | | | | | | | |
| Lupasol ® WF | 5.00 | 1.00 | 2.50 | 5.00 | 5.00 | 5.00 | 5.00 | 5.00 | — |
| Lupasol ® FG | — | — | — | — | — | — | — | — | 5.00 |
| Metal Catalyst | 0.02 | 0.02 | 0.02 | 0.20 | 0.10 | 0.10 | 0.10 | 0.10 | 0.10 |
| Amine Catalyst | 0.10 | 0.10 | 0.10 | 0.05 | 0.40 | 0.40 | 0.40 | 0.40 | 0.40 |
| DEG | 25.00 | 25.00 | 25.00 | 25.00 | 15.00 | 15.00 | 15.00 | 15.00 | 15.00 |
| CARBOWAX ® 600 | 25.00 | 25.00 | 25.00 | — | — | — | — | — | — |
| Monol | 0.00 | 0.00 | 0.00 | — | — | — | — | 5.00 | 5.00 |
| Anti-Foaming Agent | 0.50 | 0.50 | 0.50 | 0.50 | 0.50 | 0.50 | 0.50 | 0.50 | 0.50 |
| Total | 100.00 | 100.00 | 100 | 100.00 | 100.00 | 100.00 | 100.00 | 100.00 | 100.00 |
| Polyisocyanate | A | A | A | B | B | B | B | B | B |
| Composition | | | | | | | | | |
| % NCO | 25.44 | 25.44 | 25.44 | 26.25 | 26.25 | 26.25 | 26.25 | 26.25 | 26.25 |
| Isocyanate Index | 105.10 | 105.10 | 105.10 | 90.16 | 91.12 | 89.09 | 89.09 | 90.33 | 90.33 |

The 1^{st} isocyanate-reactive component A is Pluronic® L62, commercially available from BASF Corporation, and has a hydroxyl number of about 46, an actual functionality of about 1.8, a number-average molecular weight of about 2500, and about 20% terminal ethylene oxide groups.

The 1^{st} isocyanate-reactive component B is Pluracol® P2010, commercially available from BASF Corporation, and has a hydroxyl number of about 54, a theoretical functionality of about 2, a number-average molecular weight of about 2000, and is all propylene oxide.

The 1^{st} isocyanate-reactive component C is Pluracol® 1062, commercially available from BASF Corporation, and has a hydroxyl number of about 30, an actual functionality of about 1.8, a number-average molecular weight of about 4000, and about 18% terminal ethylene oxide groups.

The 1^{st} isocyanate-reactive component D is Pluracol® 1010, commercially available from BASF Corporation, and has a hydroxyl number of about 108, a theoretical functionality of about 2, a number-average molecular weight of about 1000, and is all propylene oxide.

The 2^{nd} isocyanate-reactive component is Pluracol® 1016, commercially available from BASF Corporation, and has a hydroxyl number of about 503, a theoretical functionality of about 3-4, and about 26% terminal ethylene oxide groups.

The metal catalyst is lead octoate and the amine catalyst is Dabco® R80-20 commercially available from Air Products and Chemicals. DEG is a diethylene glycol and the monol is ISALCHEM® 125 from Sasol. The anti-foaming agent is antifoam A manufactured by Dow Chemical Company.

Polyisocyanate composition A is Elastoflex® 5120 and polyisocyanate composition B is a 50/50 blend of Lupranate® MP102 and Lupranate® MM103, each of which is commercially available from BASF Corporation.

The resin components are added and mixed together in the amount indicated. Next, the resin component is mixed with the polyisocyanate component in a specified ratio to form the polyurethane elastomeric adhesive.

Before the gel time, each of the above polyurethane elastomeric adhesives is disposed between two galvanized steel panels. Each panel is about 12 inches long by 12 inches wide by ½ millimeter thick. The polyurethane elastomeric adhesive is disposed on one of the panels and the other panel is brought into contact with the polyurethane elastomeric adhesive. The polyurethane elasomeric adhesive applied can vary in weight from 45 to 90 g. Typically, 50 to 70 g of the polyurethane elastomeric adhesive is contained between the panels. It is to be appreciated that the panels may vary in thickness depending upon the particular application. The panel is then cut into 1 inch wide strips. Examples 1-6 and 8-9 did not include any reinforcing materials between the panels. Example 7 included a fibrous core as the reinforcing material. The reinforcing material is positioned on one panel and the polyurethane elastomeric adhesive is dispensed onto the fibrous core and the panel. The other panel is then brought into contact with the fibrous core and the polyurethane elastomeric adhesive.

Each 1-inch strip is then subjected to physical testing to determine the peel strength of the adhesive and panels. The physical testing is performed on an Instrom 1150. The following table summarizes the results of the physical testing.

TABLE 2
Peel Strength

| Physical Properties | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| T-Peel Strength, ppi | 15.72 | 5.97 | 6.77 | 18.48 | 16.47 | 25.37 | 19.11 | 29.00 | 18.04 |

A Control Example is prepared based upon Example 1 by eliminating the chelating agent and increasing the 1^{st} isocyanate-reactive component A by 5 parts by weight. The other components and their respective amounts remained the same. The Control Example has a peel strength of 4.10 ppi.

From the above table, Example 1 has the chelating agent present in an amount of 5 parts by weight based on 100 parts by weight of the resin composition, whereas Example 2 has 1 part by weight based on 100 parts by weight of the resin composition and Example 3 has 2.5 parts by weight based on 100 parts by weight of the resin composition. Increasing the amount of the chelating agent significantly increases the peel strength of the polyurethane elastomeric adhesive. The peel strength more than doubles when doubling the amount of the chelating agent. However, the difference between the Control Example and Examples 2 and 3 is relatively minor. Thus, it was determined that the optimal amount of the chelating agent should be from about 2.5 to about 7.5.

Referring to Example 4, a higher peel strength is obtained by increasing the amount of the 1^{st} isocyanate-reactive component A, while reducing and/or eliminating the triol, Carbowax 600, and keeping the diol, DEG, present in the same amount. It was experimentally determined that the presence of the triol lowers the peel strength and therefore, the diol is preferred. Example 4 also had a different polyisocyanate composition than Example 1, however, the polyisocyanate composition is believed to have little impact on the peel strength.

Examples 5 and 6 have the 1^{st} isocyanate-reactive component present as a blend and both Examples have reduced the amount of the DEG present therein. Without being bound by theory, it is further believed that reducing the chain extender generally, either diol or triol, further improves the peel strength. Example 6 achieves a high peel strength than Example 5, even though both have reduced DEG amounts.

Example 7 illustrates formation of the composite article with the fibrous core and the reinforcing material. Specifically, the fibrous core was formed from burlap and was about 0.5 mm thick. The composite maintains the peel strength of greater than 10 ppi.

The subject invention surprisingly discovered that the addition of the monol further improves the peel strength. With reference to Examples 8 and 9, two polyurethane elastomeric adhesives were made with a monol and different chelating agents. Example 8 includes Lupasol® WF and Example 9 includes Lupasol® FG. Lupasol® WF has a number-average molecular weight of about 25,000 and Lupasol® FG has a number-average molecular weight of about 800. Comparing Example 8 to Example 6, the peel strength increases by about 4 ppi as a result of the monol being incorporated therein. Examples 8 and 9 also illustrate the effect of chelating agents having different molecular weights on the peel strength of the polyurethane elastomeric adhesive. Specifically, the polyurethane elastomeric adhesive having the higher number-average molecular weight chelating agent present therein has a higher peel strength.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A composite article comprising:
a first substrate and a second substrate; and
a polyurethane elastomeric adhesive disposed between said first and second substrates to adhere said substrates to one another, said elastomeric adhesive comprising the reaction product of a polyisocyanate composition and a resin composition, said resin composition comprising,
a first isocyanate-reactive component comprising an internal block copolymer formed from an initiator and an alkylene oxide and comprising terminal isocyanate-reactive groups, said first isocyanate-reactive component present in an amount of from about 25 to about 75 parts by weight based on 100 parts by weight of the resin composition,
a catalyst component, and
a chelating agent comprising a branched polymeric amine having a weight-average molecular weight of from about 800 to about 200,000 and present in an amount of from about 1 to about 10 parts by weight based on 100 parts by weight of the resin composition.

2. A composite article as set forth in claim 1 further comprising a reinforcing material disposed between said substrates.

3. A composite article as set forth in claim 1 wherein said first substrate is a metal material.

4. A composite article as set forth in claim 1 wherein at least one of said first and second substrates is free of primers.

5. A composite article as set forth in claim 1 wherein said first substrate is galvanized steel.

6. A composite article as set forth in claim 1 wherein said second substrate is selected from the group of metal materials, plastic materials, and combinations thereof.

7. A composite article as set forth in claim 1 wherein said second substrate is galvanized steel.

8. A composite article as set forth in claim 1 wherein said polyurethane elastomeric adhesive further comprises a monol having a hydrocarbon chain of at least 4 atoms.

9. A composite article as set forth in claim 1 wherein said branched polymeric amine is selected from the group of ethylenimines, polyethylenimines, polyvinylamines, polyvinylamine copolymers, carboxymethylated polyethylenimines, phosphonomethylated polyethylenimines, quaternized polyethylenimines, dithiocarbamatized polyethylenimines, and mixtures thereof.

10. A composite article as set forth in claim 1 wherein said polyurethane elastomeric adhesive further comprises a second isocyanate-reactive component different than said first isocyanate-reactive component and having a hydroxyl number of from about 75 to about 550 and having a number-average molecular weight of from about 750 to about 1500.

11. A composite article as set forth in claim 1 wherein said polyisocyanate composition and said resin composition are reacted in an amount to have an isocyanate index of from about 80 to about 110.

12. A composite article as set forth in claim 1 having a peel strength of at least about 10 pounds per linear inch.

13. A polyurethane elastomeric adhesive composition comprising:
a polyisocyanate composition; and
a resin composition comprising,
a first isocyanate-reactive component comprising an internal block copolymer formed from an initiator and an alkylene oxide and comprising terminal isocyanate-reactive groups, said first isocyanate-reactive component present in an amount of from about 25 to about 75 parts by weight based on 100 parts by weight of the resin composition,
a catalyst component, and
a chelating agent comprising a branched polymeric amine having a weight-average molecular weight of from about 800 to about 200,000 and present in an amount of from about 1 to about 10 parts by weight based on 100 parts by weight of the resin composition.

14. A polyurethane elastomeric adhesive composition as set forth in claim 13 wherein said resin composition further comprises a monol having a hydrocarbon chain of at least 4 atoms and present in an amount of from about 1 to about 20 parts by weight based on 100 parts by weight of the resin composition.

15. A polyurethane elastomeric adhesive composition as set forth in claim 14 wherein said monol comprises a blend of primary alcohols, each primary alcohol having a hydrocarbon chain of at least 8 atoms and greater.

16. A polyurethane elastomeric adhesive composition as set forth in claim 13 wherein said branched polymeric amine is selected from the groups of ethylenimine, polyethylenimine, polyvinylamine, polyvinylamine copolymers, carboxymethylated polyethylenimines, phosphonomethylated polyethylenimines, quaternized polyethylenimines dithiocarbamatized polyethylenimines and mixtures thereof.

17. A polyurethane elastomeric adhesive composition as set forth in claim 13 wherein said branched polymeric amine is a polyalkylenimine having at least one primary, at least one secondary, and at least one tertiary amine group.

18. A polyurethane elastomeric adhesive composition as set forth in claim 13 wherein said polyisocyanate composition and said resin composition are reacted in an amount to have an isocyanate index of from about 80 to about 110.

19. A polyurethane elastomeric adhesive composition as set forth in claim 12 wherein said first isocyanate-reactive component has a number-average molecular weight of from about 400 to about 4000.

20. A polyurethane elastomeric adhesive composition as set forth in claim 13 wherein said terminal isocyanate-reactive groups comprise from greater than 0 to about 30 percent ethylene oxide groups based on 100 percent by weight of said first isocyanate-reactive composition.

21. A polyurethane elastomeric adhesive composition as set forth in claim 13 further comprising a second isocyanate-reactive component different than said first isocyanate-reactive component and having a hydroxyl number of from about 75 to about 550 and having a number-average molecular weight of from about 750 to about 1500.

22. A polyurethane elastomeric adhesive composition as set forth in claim 21 wherein said second isocyanate-reactive component is present in an amount of from about 1 to about 40 parts by weight based on 100 parts by weight of the resin composition.

23. A polyurethane elastomeric adhesive composition as set forth in claim 13 further comprising a chain extender component.

24. A polyurethane elastomeric adhesive composition as set forth in claim 13 wherein said chain extender component is selected from the group of ethylene glycol, diethylene glycol, propylene glycol, butylene glycol, and mixtures thereof.

25. A polyurethane elastomeric adhesive composition as set forth in claim 13 wherein said polyisocyanate component is selected from the group of monomeric diphenylmethane diisocyanate, polymeric diphenylmethane diisocyanate, and combinations thereof.

26. A resin composition comprising:
a first isocyanate-reactive component comprising an internal block copolymer formed from an initiator and an alkylene oxide and comprising terminal isocyanate-reactive groups, said first isocyanate-reactive component present in an amount of from about 25 to about 75 parts by weight based on 100 parts by weight of the resin composition and having a number-average molecular weight of from about 400 to about 4000;
a catalyst component;
a chain extender component; and
a chelating agent comprising a branched polymeric amine having a weight-average molecular weight of from about 5,000 to about 150,000 and present in an amount of from about 1 to about 10 parts by weight based on 100 parts by weight of the resin composition.

27. A resin composition as set forth in claim 26 further comprising a monol having a hydrocarbon chain of at least 4 atoms.

28. A resin composition as set forth in claim 27 wherein said monol has a hydrocarbon chain of at least 8 atoms.

29. A resin composition as set forth in claim 28 wherein said monol comprises a blend of primary alcohols, each primary alcohol having a hydrocarbon chain of at least 8 atoms and greater.

30. A resin composition as set forth in claim 27 wherein said monol is present in an amount of from about 1 to about 20 parts by weight based on 100 parts by weight of the resin composition.

31. A resin composition as set forth in claim 26 wherein said branched polymeric amine is selected from the groups of ethylenimine, polyethylenimine, polyvinylamine, polyvinylamine copolymers, carboxymethylated polyethylenimines, phosphonomethylated polyethylenimines, quaternized polyethylenimines dithiocarbamatized polyethylenimines and mixtures thereof.

32. A resin composition as set forth in claim 26 wherein said terminal isocyanate-reactive groups comprise from greater than 0 to about 30 percent ethylene oxide groups based on 100 percent by weight of said first isocyanate-reactive composition.

33. A resin composition as set forth in claim 26 further comprising a second isocyanate-reactive component different than said first isocyanate-reactive component and having a hydroxyl number of from about 75 to about 550 and having a number-average molecular weight of from about 750 to about 1500.

34. A resin composition as set forth in claim 33 wherein said second isocyanate-reactive component is present in an amount of from about 1 to about 40 parts by weight based on 100 parts by weight of the resin composition.

35. A resin composition as set forth in claim 26 further comprising an antifoaming agent.
